(19) United States
(12) Patent Application Publication
(10) Pub. No.: US 2023/0039832 A1
(43) Pub. Date: Feb. 9, 2023

(54) METHOD AND SYSTEM FOR TRANSACTION OF DIGITAL ASSET

(71) Applicant: LINE Corporation, Tokyo (JP)

(72) Inventor: Yooho KIM, Seongnam-si (KR)

(73) Assignee: LINE Corporation, Tokyo (JP)

(21) Appl. No.: 17/881,799

(22) Filed: Aug. 5, 2022

(30) Foreign Application Priority Data
Aug. 6, 2021 (KR) 10-2021-0103978

(51) Int. Cl. G06Q 20/38; G06Q 20/40

(52) U.S. Cl. CPC G06Q 20/389; G06Q 20/3825; G06Q 20/407; G06Q 20/3829

(57) ABSTRACT

A method for transaction of digital asset is provided, including receiving digital asset transaction request information from a user terminal, verifying, by a blockchain network, the transaction request information, and when the verifying the transaction request information is completed, generating, by the blockchain network, information associated with the digital asset, in which the information associated with the digital asset includes a reputation of the digital asset.

### CROSS-REFERENCE TO RELATED APPLICATION

This application claims priority under 35 U.S.C § 119 to Korean Patent Application No. 10-2021-0103978, filed in the Korean Intellectual Property Office on Aug. 6, 2021, the entire contents of which are hereby incorporated by reference.

### BACKGROUND

### Technical Field

The present disclosure relates to a method and/or a system for transaction of digital asset. For example, at least some example embodiments relate to a method and/or a system for transaction of blockchain network-based digital asset.

### Description of the Related Art

Recently, digital assets such as in-game items, digital contents, cryptocurrency, and the like are actively transacted on various online platforms. Some purchases and sales of digital assets are performed between a platform operator and a user on platforms where digital assets are produced and provided. However, the frequency of digital asset transactions or inter-individual digital asset transactions is increasing on a private transacting system that operates independently of these platforms. For example, various in-game items such as clothes, weapons, and the like for game players are transacted on online game platforms, and when the in-game items are subsequently transacted between users on private transacting systems, the price can rise.

However, when the digital assets are transacted through a distribution channel other than the transaction service provided by the operator of the platform that produced the digital asset, transaction accidents may occur, such as the payment for digital assets not being transmitted properly between the parties to the transaction, or the failure of digital assets to be transmitted after payment is made. In addition, when the platform that produced the digital asset stops operation or there is no transaction due to decreased interest in the digital asset, there is a concern that the corresponding digital asset has no real value but will remain as dummy data.

### SUMMARY

In order to address the problems mentioned above, the present disclosure provides a method for, a non-transitory computer-readable storage medium storing instructions for, and/or a system for transaction of digital asset.

The present disclosure may be implemented in a variety of ways, including a method, a device, or a computer program stored in a computer-readable storage medium.

At least some example embodiments relate to a method of transacting a digital asset by an information processing system.

In some example embodiments, the method includes receiving, from a user terminal, transaction request information associated with the digital asset; verifying the transaction request information using a blockchain network; and generating information associated with the digital asset using the blockchain network such that the information associated with the digital asset includes a reputation of the digital asset.

In some example embodiments, the method further includes accumulating the reputation in a fund associated with the digital asset.

In some example embodiments, the verifying the transaction request information includes generating and storing a transaction history of the digital asset based on the digital asset transaction request information; generating a first signature key for the digital asset; transmitting the first signature key to the user terminal; generating a second signature key for the digital asset; and storing the second signature key in association with the digital asset.

In some example embodiments, the method further includes receiving a return request information; verifying the return request information using the blockchain network; and burning the digital asset, in response to the verifying confirming a validity of the return request information.

In some example embodiments, the verifying the return request information includes determining whether a sender of the return request information is an owner of the digital asset based on an encryption key included in the return request information.

In some example embodiments, the burning the digital asset includes: calculating a fund associated with the digital asset based on the return request information; deleting information associated with the digital asset or generating an invalid flag associated with the digital asset; and transmitting return information to a sender of the return request information such that the return information includes the fund associated with the digital asset.

In some example embodiments, the return request information is received from the user terminal, and the method further includes transmitting, the user terminal, burn information of the digital asset, in response to the burning of the digital asset.

In some example embodiments, the user terminal is configured to output a non-recoverability message or a returned fund of the digital asset based on the burn information.

In some example embodiments, the method further includes receiving a request for withdrawal of a fund associated with the digital asset from a sender of the return request information; and remitting, to the sender, an amount equivalent to the fund associated with the digital asset or storing information associating the amount equivalent to the fund with the sender.

In some example embodiments, the request for withdrawal of the fund associated with the digital asset is received from the user terminal, and wherein the user terminal is configured to receive the amount equivalent to the fund associated with the digital asset or output the information associated with the amount equivalent to the fund.

In some example embodiments, the method further includes converting a transaction amount or the reputation of the digital asset into cash using a digital currency exchange, in response to transacting the digital asset using the digital currency exchange.

In some example embodiments, the digital asset includes a non-fungible token (NFT)-based digital asset.

In some example embodiments, the information associated with the digital asset further includes information on at least one of a transaction date, a producer, a purchaser, a seller, a price or ownership information associated with the digital asset.

In some example embodiments, the method further includes transmitting, to the user terminal, the information associated with the digital asset including the reputation of the digital asset, wherein the user terminal is configured to confirm the reputation of the digital asset based on the information associated with the digital asset transmitted thereto.

In some example embodiments, the user terminal is configured to extract information on a transaction date, a producer, a purchaser, a seller or a price of the digital asset from the information associated with the digital asset.

At least some example embodiments relate to a non-transitory computer-readable recording medium storing instructions for executing the method of transacting a digital asset by an information processing system.

At least some example embodiments relate to a system configured to transact a digital asset.

In some example embodiments, the system includes a user terminal; and an information processing system including, a memory configured to store computer-readable instructions, and a processor connected to the memory and configured to the computer-readable instructions to configure the information processing system to, receive, from the user terminal, transaction request information associated with the digital asset verify the transaction request information using a blockchain network, and generate information associated with the digital asset using the blockchain network such that the information associated with the digital asset includes a reputation of the digital asset.

In some example embodiments, the computer-readable instructions, when executed by the processor, further configure the information processing system to accumulate the reputation in a fund associated with the digital asset.

In some example embodiments, the user terminal is configured to transmit the digital asset transaction request information to the information processing system, receive information associated with the digital asset, when the information processing system verifies the transaction request information using the blockchain network, and confirm the reputation of with the digital asset included in the information received from the information processing system.

In some example embodiments, the user terminal is configured to transmit return request information to the information processing system, and receive burn information of the digital asset, in response to the information processing system verifying, based on the return request information, that the return request is completed using the blockchain network.

According to some embodiments, by generating information on the reputation associated with the digital asset and accumulating the generated information in the fund associated with the digital asset, it is possible to compensate for the permanent value of the digital asset even when there is no subsequent transaction of the digital asset. That is, even when the operation of the platform that produced the digital asset is stopped or there is no transaction for decreasing interest in the digital asset, the owner of the digital asset is able to receive a refund of an amount equivalent to the fund associated with the digital asset, and this can inhibit (or, alternatively, prevent) the loss to the owner of the digital asset.

According to some embodiments, when the digital asset is transacted, information on the reputation associated with the digital asset is expressed to purchasers as information associated with the digital asset, and as the digital asset continues to be transacted, the reputation associated with the digital asset is accumulated in the fund associated with the digital asset, and this enables the purchaser to easily recognize the value of the digital asset, and thus facilitates the transactions of the digital asset.

According to some embodiments, by verifying the transaction request information or digital asset return request information through the blockchain network, even when the digital asset is transacted through a distribution channel other than the transaction service provided by the operator of the platform that produced the digital asset, it is possible to inhibit (or, alternatively, prevent) transaction accidents such as forgery or the like of data related to the digital assets.

The effects of the present disclosure are not limited to the effects described above, and other effects not mentioned will be able to be clearly understood by those of ordinary skill in the art (referred to as “those skilled in the art”) from the description of the claims.

### BRIEF DESCRIPTION OF THE DRAWINGS

The above and other objects, features and advantages of the present disclosure will become more apparent to those of ordinary skill in the art by describing in detail example embodiments thereof with reference to the accompanying drawings, in which:

FIG. 1 is a diagram illustrating an example of a method for transaction of digital asset between a seller and a purchaser on a digital asset transaction platform according to an embodiment;

FIG. 2 is a schematic diagram illustrating a configuration in which an information processing system 230 is communicatively connected to a plurality of user terminals 210_1, 210_2, and 210_3 to provide a digital asset transaction service according to an embodiment;

FIG. 3 is a block diagram illustrating the user terminal 210 and the information processing system 230 according to an embodiment;

FIG. 4 is a functional block diagram illustrating an internal configuration of the information processing system 230 according to an embodiment;

FIG. 5 is a flowchart illustrating a method for performing transaction of digital asset between the user terminal, and a transaction management unit, a blockchain server and a value management unit of the information processing system according to an embodiment;

FIG. 6 is a diagram illustrating an example of a user interface on which the transaction of the digital asset is performed according to an embodiment;

FIG. 7 is a flowchart illustrating a method for performing digital asset burning between the user terminal, and the transaction management unit, the blockchain server and the value management unit of the information processing system according to an embodiment;

FIG. 8 is a diagram illustrating an example of a user interface on which digital asset burning is performed according to an embodiment;

FIG. 9 is a flowchart illustrating a method for transaction of digital asset according to an embodiment;

FIG. 10 is a flowchart illustrating a method for burning a digital asset according to an embodiment; and

FIG. 11 is a flowchart illustrating a method for transaction of digital asset by the user terminal according to an embodiment.

### DETAILED DESCRIPTION

Hereinafter, specific details for the practice of the present disclosure will be described in detail with reference to the accompanying drawings. However, in the following description, detailed descriptions of well-known functions or configurations will be omitted when it may make the subject matter of the present disclosure rather unclear.

In the accompanying drawings, the same or corresponding components are assigned the same reference numerals. In addition, in the following description of the embodiments, duplicate descriptions of the same or corresponding components may be omitted. However, even if descriptions of components are omitted, it is not intended that such components are not included in any embodiment.

Advantages and features of the disclosed embodiments and methods of accomplishing the same will be apparent by referring to embodiments described below in connection with the accompanying drawings. However, the present disclosure is not limited to the embodiments disclosed below, and may be implemented in various forms different from each other, and the present embodiments are merely provided to make the present disclosure complete, and to fully disclose the scope of the disclosure to those skilled in the art to which the present disclosure pertains.

The terms used herein will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in specific cases, certain terms may be arbitrarily selected by the applicant, and the meaning of the terms will be described in detail in a corresponding description of the embodiments. Therefore, the terms used in the present disclosure should be defined based on the meaning of the terms and the overall content of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to play one or more processors. Accordingly, as an example, the “module” or “unit” may include components such as software components, object-oriented software components, class components, and task components, and at least one of processes, functions, attributes, procedures, subroutines, program code segments, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

According to an embodiment, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination for processing devices, e.g., a combination of a DSP and a microprocessor, a combination of a plurality of microprocessors, a combination of one or more microprocessors in conjunction with a DSP core, or any other combination of such configurations. In addition, the “memory” should be interpreted broadly to encompass any electronic component that is capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory integrated with the processor is in electronic communication with the processor.

In the present disclosure, a “digital asset” may refer to an asset configured in a digital data form for which a user is given the right or authority to use, rent, share, or own the same. The digital asset includes digital content such as digital documents, music, images, videos, and the like, or digital data that can be transacted, transferred or distributed, or stored in a digital medium or device, or transmitted through a digital medium, but are not limited thereto. For example, the digital asset may include content such as music, logos, artwork, and other forms of images or videos, in-game items, cryptocurrencies, and the like. In another example, the digital asset may include a non-fungible token (NFT)-based digital asset.

In the present disclosure, “reputation” may refer to a permanent value associated with the digital asset, which is managed separately from the transaction price of the digital asset. The reputation may be determined as an amount corresponding to a portion of the transaction price or a separate fee each time the digital asset is transacted, and accumulated in a fund associated with the digital asset. In addition, when the digital asset is burned at the request of the owner of the digital asset or for other reasons, its associated fund may be returned to the owner of the corresponding digital asset.

In the present disclosure, a “non-fungible token (NFT)” is a token or digital asset that has its own unique value, and may refer to an electronic form of money, certificates, and the like that is incompatible between tokens. For example, the NFT may be implemented in the form of a blockchain-based cryptographic asset such as Ethereum, but is not limited thereto. The NFT may be used as a digital asset that represents an asset or interest of unique number, such as electronic forms of in-game items, photos, artwork, documents, and the like.

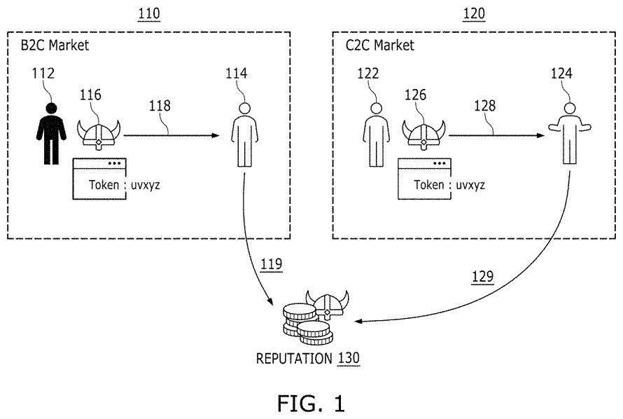

FIG. 1 is a diagram illustrating an example of a method for managing transaction data of digital assets 116 and 126 between sellers 112 and 122 and purchasers 114 and 124 on digital asset transaction platforms according to an embodiment. As illustrated, the digital asset 116 may be managed to be transacted on a digital asset transaction platform that operates a business to consumer (B2C) market 110 between users of this platform. Additionally, the digital asset 126 may be managed to be transacted on another digital asset transaction platform that operates a consumer to consumer (C2C) market 120 between users of this platform. While FIG. 1 illustrates the digital assets 116 and 126 as denoted by separate reference numbers, they may refer to the same digital asset. That is, after the digital assets 116 and 126 are produced by the platform operator 112 in the B2C market 110 and sold to the purchaser 114, the purchaser of the digital asset or another user 122 transferred with the asset from the purchaser may sell the asset to yet another purchaser 124 in the C2C market 120, and the relevant data may be managed on the digital asset transaction platform.

In an embodiment, the “B2C market” may refer to a platform or service on which a transaction between a producer and a purchaser of digital assets can be executed. For example, an online game producer or an online game platform operating company may sell various items used in games to game users as digital assets on the B2C market. Meanwhile, the “C2C market” may refer to another digital asset transaction platform or service independent of the B2C market, in which a purchaser or owner of a digital asset can sell the digital asset to other users. For example, a user who purchases a game item in the game from an online game producer may sell the game item to another purchaser on the C2C market in exchange for a certain amount of transaction price.

In an embodiment, transactions 118 and 128 of the digital assets 116 and 126 between the sellers 112 and 122 and the purchasers 114 and 124 may be initiated by transmission of transaction request information from the purchasers 114 and 124. For example, the purchasers 114 and 124 may transmit the transaction request information to a blockchain network (or a blockchain server) or an external server (e.g., an information processing system) by using their user terminals. In this case, a portion of the price paid by the purchasers 114 and 124 for the purchase of the digital asset or the commission of the purchase transaction may be accumulated (119, 129) in a fund associated with the digital asset by the information processing system as reputation 130 of the digital asset. In the fund associated with the digital asset, the reputation determined in each of the subsequent transactions of the digital asset may be accumulated.

In an embodiment, when the owners of the digital assets 116 and 126 such as the purchasers 114 and 124 and the like request the digital asset burning, the fund associated with the digital asset may be processed to be returned to the owner. That is, when the digital asset is burned, the owner of the digital asset may transmit a request for withdrawal of an amount equivalent to the fund associated with the digital asset to the information processing system through the user terminal. As described above, by calculating the reputation separately from the transaction price of the digital asset and accumulating the reputations into the fund associated with the digital asset and managing the same, in the event that there are no subsequent transactions for the digital asset or the operation of the platform or service associated with the digital asset is stopped, the owner of the corresponding digital asset may be paid an amount corresponding to the reputation of the digital asset through the return of the fund, and the dummy data on the digital asset transaction platform may be processed to consume minimal resources. For example, in the event that the provision of game services is stopped due to the circumstances of the platform operating company, or the service that utilizes the digital assets is stopped and the digital asset is scheduled to be destroyed, the users of the online gaming platform may be paid an amount equivalent to the funds associated with digital assets, and the data on the corresponding digital assets on the online game platform may be deleted or managed with an invalid flag.

In an embodiment, information on transactions of digital assets, reputation and funds determined in connection with the transactions, and the like may be generated, stored, and managed by a blockchain network operating while being connected to the information processing system. In this case, verifying a digital asset transaction request or determining a reputation, verifying a request for digital asset burning, verifying a request for fund return, and the like may be executed by the blockchain network. In addition, authenticating or verifying the owner of the corresponding digital asset or of the request of the owner in connection with an act of transacting digital asset such as transaction of digital asset, determination of reputation, digital asset burning, fund return, and the like may be performed using a digital signature or signature key generated in association with the owner.

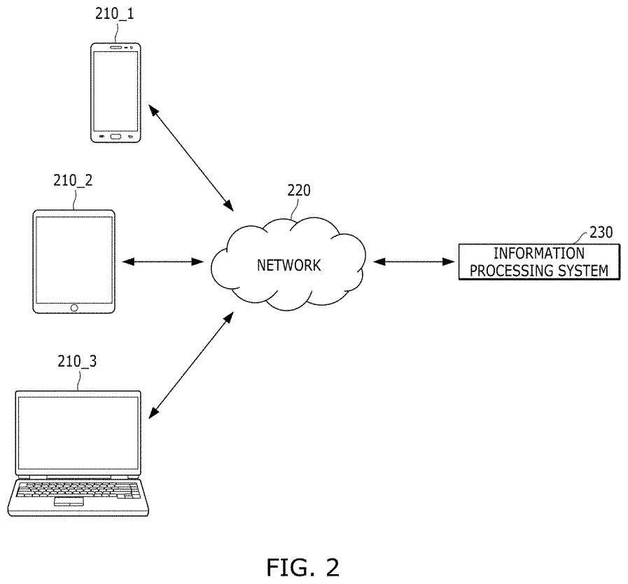

FIG. 2 is a schematic diagram illustrating a configuration in which an information processing system 230 is communicatively connected to a plurality of user terminals 210_1, 210_2, and 210_3 to provide a digital asset transaction service according to an embodiment. The information processing system 230 may include a system capable of providing a digital asset transaction service to a plurality of user terminals 210_1, 210_2, and 210_3 through a network 220. According to an embodiment, the information processing system 230 may include one or more server devices and/or databases, or one or more distributed computing devices and/or distributed databases based on cloud computing services that can store, provide and execute computer-executable programs (e.g., downloadable applications) and data related to the digital asset transaction service. The digital asset transaction service provided by the information processing system 230 may be provided to the user through a digital asset transaction application installed in each of the plurality of user terminals 210_1, 210_2, and 210_3.

The plurality of user terminals 210_1, 210_2, and 210_3 may communicate with the information processing system 230 through the network 220. The network 220 may be configured to enable communication between the plurality of user terminals 210 and the information processing system 230. The network 220 may be configured as a wired network such as Ethernet, a wired home network (Power Line Communication), a telephone line communication device and RS-serial communication, a wireless network such as a mobile communication network, a wireless LAN (WLAN), Wi-Fi, Bluetooth, and ZigBee, or a combination thereof, depending on the installation environment. The method of communication may include a communication method using a communication network (e.g., mobile communication network, wired Internet, wireless Internet, broadcasting network, satellite network, and the like) that may be included in the network as well as short-range wireless communication between the user terminals 210_1, 210_2, and 210_3, but embodiments are not limited thereto. For example, the network 220 may include any one or more of networks including a personal area network (PAN), a local area network (LAN), a campus area network (CAN), a metropolitan area network (MAN), a wide area network (WAN), a broadband network (BBN), the Internet, and the like. In addition, the network 220 may include any one or more of network topologies including a bus network, a star network, a ring network, a mesh network, a star-bus network, a tree or hierarchical network, and the like, but not limited thereto.

In FIG. 2, the mobile phone terminal 210_1, the tablet terminal 210_2, and the PC terminal 210_3 are illustrated as the examples of the user terminals, but are not limited thereto, and the user terminals 210_1, 210_2, and 210_3 may be any computing device that is capable of wired and/or wireless communication and that can be installed with the digital asset transaction application and execute the same. For example, the user terminals 210_1, 210_2, and 210_3 may include a smart phone, a mobile phone, a navigation system, a computer, a notebook computer, a digital broadcasting terminal, Personal Digital Assistants (PDA), a Portable Multimedia Player (PMP), a tablet PC, a game console, a wearable device, an internet of things (IoT) device, a virtual reality (VR) device, an augmented reality (AR) device, and the like. In addition, while FIG. 2 illustrates three user terminals 210_1, 210_2, and 210_3 in communication with the information processing system 230 through the network 220, the embodiments are not limited thereto, and accordingly, a different number of user terminals 210_1, 210_2, and 210_3 may be configured to be in communication with the information processing system 230 through the network 220.

The information processing system 230 may receive an input for requesting a digital asset transaction, from the user terminals 210_1, 210_2, and 210_3 on which the digital asset transaction application is running. When the input for requesting transaction of digital asset is received, the information processing system 230 may provide a digital asset transaction management service and/or a digital asset value management service between the user terminals 210_1, 210_2, and 210_3 on which the digital asset transaction application is running.

According to an embodiment, in order to provide the digital asset transaction service, the information processing system 230 may receive transaction request information or return request information from the user terminals 210_1, 210_2, and 210_3, and transmit information associated with digital asset to the user terminals 210_1, 210_2, and 210_3. In this case, the information associated with the digital asset may include information on transaction date, producer, purchaser, seller, price, or ownership information associated with the transaction of the digital asset. For example, when an input of digital asset transaction request is received, the information processing system 230 may verify the transaction request information, and when the verification is completed, generate the information associated with the digital asset and transmit it to the user terminal.

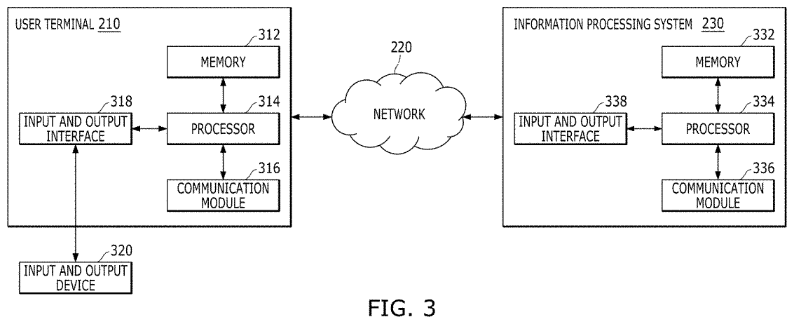

FIG. 3 is a block diagram illustrating the user terminal 210 and the information processing system 230 according to an embodiment. The user terminal 210 may refer to any computing device that is capable of executing the digital asset transaction application and also capable of wired/wireless communication, and may include the mobile phone terminal 210_1, the tablet terminal 210_2, and the PC terminal 210_3 of FIG. 2, for example. As illustrated, the user terminal 210 may include a memory 312, a processor 314, a communication module 316, and an input and output interface 318. Likewise, the information processing system 230 may include a memory 332, a processor 334, a communication module 336, and an input and output interface 338. As illustrated in FIG. 3, the user terminal 210 and the information processing system 230 may be configured to communicate information and/or data through the network 220 using the respective communication modules 316 and 336. In addition, an input and output device 320 may be configured to input information and/or data to the user terminal 210 or to output information and/or data generated from the user terminal 210 through the input and output interface 318.

The memories 312 and 332 may include any non-transitory computer-readable recording medium. According to an embodiment, the memories 312 and 332 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 210 or the information processing system 230 as a separate permanent storage device that is separate from the memory. In addition, an operating system and at least one program code (e.g., a code for a digital asset transaction application, and the like installed and driven in the user terminal 210) may be stored in the memories 312 and 332.

These software components may be loaded from a computer-readable recording medium separate from the memories 312 and 332. Such a separate computer-readable recording medium may include a recording medium directly connectable to the user terminal 210 and the information processing system 230, and may include a non-transitory computer-readable recording medium such as a floppy drive, a disk, a tape, a DVD/CD-ROM drive, a memory card, and so on, for example. As another example, the software components may be loaded into the memories 312 and 332 through the communication modules 316 and 336 rather than the computer-readable recording medium. For example, at least one program may be loaded into the memories 312 and 332 based on a computer program (e.g., an application that provides the digital asset transaction service service) installed by files provided by the developers or a file distribution system for distributing an installation file of the application through the network 220.

The processors 314 and 334 may be configured to process the instructions of the computer program to transform the processors 314 and 334 into special purpose processors that maintain and utilize a reputation associated with digital assets. The instructions may be provided to the processors 314 and 334 from the memories 312 and 332 or the communication modules 316 and 336. For example, the processors 314 and 334 may be configured to execute the received instructions according to a program code stored in a recording device such as the memories 312 and 332.

The communication modules 316 and 336 may provide a configuration or function for the user terminal 210 and the information processing system 230 to communicate with each other through the network 220, and may provide a configuration or function for the user terminal 210 and/or the information processing system 230 to communicate with another user terminal or another system (e.g., a separate cloud system, a separate digital asset transaction management system, a digital asset value management system, a separate blockchain network, and the like). For example, a request (e.g., a digital asset transaction request, a digital asset return request) generated by the processor 314 of the user terminal 210 according to the program code stored in the recording device such as the memory 312 or the like may be transmitted to the information processing system 230 through the network 220 under the control of the communication module 316. Conversely, a control signal or a command provided under the control of the processor 334 of the information processing system 230 may be received by the user terminal 210 through the communication module 316 of the user terminal 210 through the communication module 336 and the network 220. For example, the user terminal 210 may receive information associated with the digital asset or burn information of the digital asset from the information processing system 230 through the communication module 316.

The input and output interface 318 may be a means for interfacing with the input and output device 320. As an example, the input device may include a device such as a camera including an image sensor, a keyboard, a microphone, a mouse, and so on, and the output device may include a device such as a display, a speaker, a haptic feedback device, and so on. As another example, the input and output interface 318 may be a means for interfacing with a device such as a touch screen or the like that integrates a configuration or function for performing inputting and outputting. For example, when the processor 314 of the user terminal 210 processes the instructions of the computer program loaded in the memory 312, a service screen or content, which is configured with the information and/or data provided by the information processing system 230 or other user terminals 210, may be displayed on the display through the input and output interface 318. While FIG. 3 illustrates that the input and output device 320 is not included in the user terminal 210, embodiments are not limited thereto, and an input and output device may be configured as one device with the user terminal 210. In addition, the input and output interface 338 of the information processing system 230 may be a means for interfacing with a device (not illustrated) for inputting or outputting that may be connected to, or included in the information processing system 230. While FIG. 3 illustrates the input and output interfaces 318 and 338 as the components configured separately from the processors 314 and 334, embodiments are not limited thereto, and the input and output interfaces 318 and 338 may be configured to be included in the processors 314 and 334.

The user terminal 210 and the information processing system 230 may include more than those components illustrated in FIG. 3. Meanwhile, most of the related components may not necessarily require exact illustration. According to an embodiment, the user terminal 210 may be implemented to include at least a part of the input and output device 320 described above. In addition, the user terminal 210 may further include other components such as a transceiver, a Global Positioning System (GPS) module, a camera, various sensors, a database, and the like. For example, when the user terminal 210 is a smartphone, it may include components generally included in the smartphone. For example, in an implementation, various components such as an acceleration sensor, a gyro sensor, a camera module, various physical buttons, buttons using a touch panel, input and output ports, a vibrator for vibration, and so on may be further included in the user terminal 210.

According to an embodiment, the processor 314 of the user terminal 210 may be configured to operate the digital asset transaction application or a web browser application. In this case, a program code associated with the above application may be loaded into the memory 312 of the user terminal 210. While the application is running, the processor 314 of the user terminal 210 may receive information and/or data provided from the input and output device 320 through the input and output interface 318 or receive information and/or data from the information processing system 230 through the communication module 316, and process the received information and/or data and store it in the memory 312. In addition, such information and/or data may be provided to the information processing system 230 through the communication module 316.

While the digital asset transaction application is running, the processor 314 may receive texts, images, and the like, which may be inputted or selected through the input device 320 such as a touch screen, a keyboard, and the like connected to the input and output interface 318, and store the received texts, and/or images in the memory 312 or provide them to the information processing system 230 through the communication module 316 and the network 220. For example, the processor 314 may receive a digital asset transaction request or the like through the input device such as the touch screen, the keyboard, or the like. Accordingly, the received request and/or information may be provided to the information processing system 230 through the communication module 316 and the network 220.

The processor 314 of the user terminal 210 may execute instructions that convert the processor 314 into a special purpose computer that is configured to manage, process, and/or store the information and/or data received from the input and output device 320, another user terminal, the information processing system 230 and/or a plurality of external systems. The information and/or data processed by the processor 314 may be provided to the information processing system 230 through the communication module 316 and the network 220. The processor 314 of the user terminal 210 may transmit the information and/or data to the input and output device 320 through the input and output interface 318 to output the same. For example, the processor 314 may display the received information and/or data on a screen of the user terminal.

The processor 334 of the information processing system 230 may execute instructions that convert the processor 334 into a special purpose computer that is configured to manage, process, and/or store information and/or data received from the plurality of user terminals 210 and/or a plurality of external systems. The information and/or data processed by the processor 334 may be provided to the user terminals 210 through the communication module 336 and the network 220.

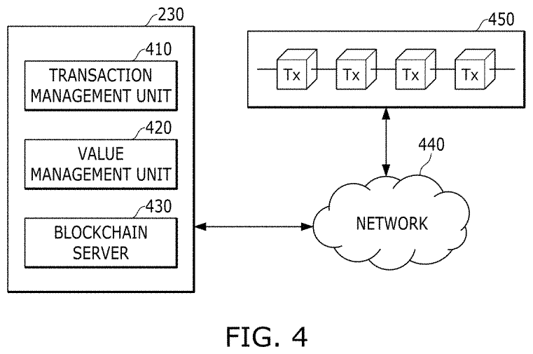

FIG. 4 is a functional block diagram illustrating an internal configuration of the information processing system 230 according to an embodiment. As illustrated, the processor 334 of the information processing system 230 may execute instructions that convert the processor 334 into a special purpose computer that functions as a transaction management unit 410, a value management unit 420, and a blockchain server 430.

The transaction management unit 410 may transmit the digital asset transaction request information received from the user terminal to the blockchain server 430. In this case, the blockchain server 430 may verify the digital asset transaction request information and generate information associated with the digital asset. Additionally or alternatively, the transaction management unit 410 may generate and store information associated with the digital asset based on the digital asset transaction request information. For example, the transaction management unit 410 may generate information associated with the corresponding digital asset based on a purchaser, a seller, a transaction date, a transaction price, and the like included in the digital asset transaction request information. When receiving transaction request information of a subsequent transaction of the digital asset having a transaction history from the user terminal, the transaction management unit 410 may update the information associated with the corresponding digital asset.

According to an embodiment, the transaction management unit 410 may generate a signature key for use in the transaction of a digital asset or in the verification or authentication of an owner. For example, the transaction management unit 410 may use asymmetric key cryptography to generate a signature key. In response to the digital asset transaction request information, the transaction management unit 410 may generate a first signature key (e.g., a secret key) for a corresponding digital asset and transmit the generated key to the user terminal. In addition, the transaction management unit 410 may generate a second signature key (e.g., a public key) for the digital asset and store the generated key in association with the digital asset. In this case, the owner who purchases the digital asset can prove that he is the owner of the digital asset by using the first signature key corresponding to the second signature key.

In an embodiment, the transaction price of the digital asset included in the digital asset transaction request information received by the transaction management unit 410 from the user terminal may be displayed in units of digital currency. In this case, the transaction management unit 410 may include information obtained by converting the transaction amount or reputation of the digital asset into cash through an external digital currency exchange (e.g., a crypto exchange) in the information associated with the digital asset.

In an embodiment, the transaction management unit 410 may receive from the user terminal a request for information (e.g., information on transaction date, producer, purchaser, seller, or price of the digital asset) associated with the digital asset. In this case, the transaction management unit 410 may transmit the information associated with the digital asset to the user terminal.

According to an embodiment, the transaction management unit 410 may receive digital asset return request information from the user terminal. The transaction management unit 410 may determine whether or not the sender of the return request information is the owner of the digital asset, based on the private key included in the digital asset return request information. When it is determined that the owner of the digital asset is the sender of the return request information, the transaction management unit 410 may transmit the return request information to the blockchain server 430 for burning of the digital asset.

When the verifying the digital asset transaction request information is completed by the blockchain server 430, the value management unit 420 may receive an amount equivalent to the reputation of the digital asset from the user terminal. For example, the reputation of the digital asset may be calculated based on a portion of an amount equivalent to the price of the digital asset. In another example, the reputation of the digital asset may be calculated based on a transaction fee of the digital asset. In addition, when a subsequent transaction of the digital asset occurs, the reputation of the digital asset may be newly calculated and it may be different from the reputation calculated in the previous transaction. For example, when a first purchaser initially purchases a digital asset from the producer of the digital asset, the reputation may be determined as 20% of the purchase price of the digital asset. Next, when a second purchaser purchases the same digital asset from the first purchaser, the reputation may be determined as 10% of the purchase price of the digital asset. The calculated reputation of the digital asset may be accumulated by the value management unit 420 as a fund associated with the digital asset.

Meanwhile, when verifying the digital asset return request is completed by the blockchain server 430 and it is determined that the digital asset is to be burned, the value management unit 420 may receive, from the user terminal, information requesting withdrawal of an amount equivalent to the fund associated with the digital asset. In addition, when it is determined that the digital asset is to be burned, the value management unit 420 may pay the amount equivalent to the fund associated with the digital asset to the user terminal or store information associated with the amount equivalent to the fund. In this case, the information associated with the amount equivalent to the fund may include information associated with the sender of the digital asset return request information.

The blockchain server 430 may be connected to a blockchain network 450 through a network 440 and manage the verification of the digital asset transaction request information, verification of the return request, and the like, which is executed by the blockchain network 450. In general, the blockchain network 450 may be a system in a distributed environment, which is capable of generating, storing, and updating the transaction history of digital assets using a shared ledger. The blockchain network 450 may use a decentralized or distributed consensus mechanism for the verification of the digital asset transaction request information, the verification of a return request, and the like. In particular, all verification nodes (e.g., the information processing system 230 (or system for transaction of digital asset)) connected to the blockchain network 450 may execute same (or agreed) consensus algorithm on same transaction history to verify or approve the transaction history. Since the blockchain network 450 uses such a decentralized structure and consensus algorithm, it is possible to inhibit (or, alternatively, prevent) forgery and falsification of transaction history of digital assets by a third party.

In an embodiment, the blockchain network 450 is formed to be connected to one or more blocks that record data related to transactions of digital assets. In addition, the generated blocks may be stored and maintained identically in one or more nodes. Blocks including information associated with digital assets that are generated and updated in the information processing system (or system for transaction of digital asset) may be transmitted to the blockchain network 450 to be stored and maintained.

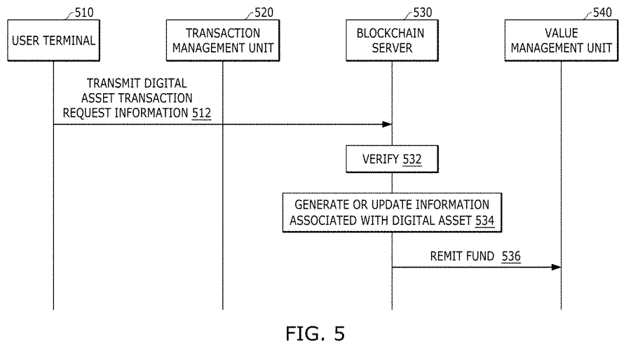

FIG. 5 is a flowchart illustrating a method for performing transaction of digital asset between a user terminal, and a transaction management unit, a blockchain server and a value management unit of the information processing system according to an embodiment.

As illustrated, at operation 512, a user terminal 510 may transmit the digital asset transaction request information to a blockchain server 530 (or blockchain network) through a transaction management unit 520 of the information processing system. The digital asset transaction request may be initiated by a user input (not illustrated) to the user terminal 510 of the user.

At operation 532, the blockchain server 530 may verify the transaction history information included in the digital asset transaction request information received from the transaction management unit 520. In this case, the blockchain server 530 may use a decentralized consensus mechanism for the verifying the digital asset transaction request information.

At operation 534, when the verification is completed, the blockchain server 530 may generate information associated with the digital asset and record the generated information in the blockchain network. The information associated with the digital asset may include information on transaction date, purchaser, seller, and price of the digital asset, and may further include information on producer or current ownership of the digital asset.

At operation 536, when the verifying the digital asset transaction request information is completed by the blockchain server 530, a value management unit 540 may receive an amount equivalent to the reputation of the digital asset from the blockchain server 530 and accumulate it in a fund associated with the digital asset. For example, the reputation of the digital asset may be calculated based on a portion of an amount equivalent to the price of the digital asset. In another example, the reputation of the digital asset may be calculated based on a transaction fee of the digital asset. When a subsequent transaction of the digital asset occurs, the reputation of the digital asset may be newly calculated and it may be different from the reputation calculated in the previous transaction. According to another embodiment, the value management unit 540 may receive the corresponding amount information and the like from the blockchain server 530 and record it in the form of data without receiving the corresponding amount from the blockchain server 530. In this case, the data may include information on the owner of the cash equivalent to the reputation of the digital asset.

The user terminal 510 may be an example of the user terminal 210 and the transaction management unit 520, blockchain server 530 and value management unit 540 may be examples of the corresponding functions performed by the processor 334 of the information processing system 230 discussed with reference to FIGS. 3 and 4.

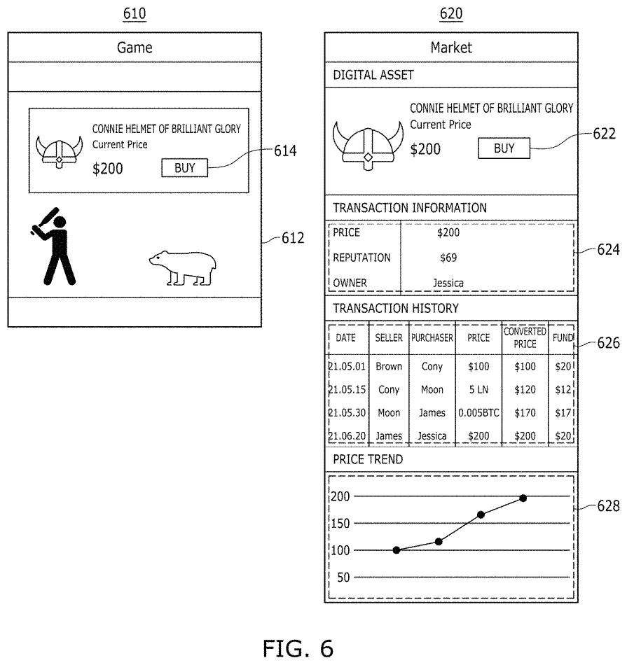

FIG. 6 is a diagram illustrating an example of a user interface on which the transaction of the digital asset is performed according to an embodiment. As illustrated, the user may execute a transaction request for a digital asset through a first operation 610 or a second operation 620 for the user interface displayed on a display of the user terminal.

For example, the first operation 610 illustrates an example of using a user interface for digital asset transaction request on a B2C market for in-game item transaction. In the first operation 610, an icon 614 for purchase of digital asset (e.g., in-game item) is displayed on a screen 612 on which a game service is provided. While playing the game, the user may touch the icon 614 displayed on the screen 612 to initiate a digital asset transaction request.

The second operation 620 illustrates an example of using a user interface for digital asset transaction request through a digital asset transaction application for a C2C market for in-game item transaction, for example. In the second operation 620, an icon 622 for purchase of digital asset and information 624, 626, and 628 associated with the digital asset are displayed on a screen provided by the digital asset transaction application. The user may touch the icon 622 on the screen provided by the digital asset transaction application to initiate a digital asset transaction request. In this case, information associated with the digital asset to be transacted may be displayed together on the screen.

In an embodiment, for the information associated with the digital asset, transaction information 624 of the digital asset, transaction history 626 of the digital asset, and transaction price trend 628 of the digital asset may be displayed. The digital asset transaction information 624 may include information on the current price of the digital asset, the reputation, and the owner of the current digital asset. The transaction history 626 of the digital asset may include information on transaction date, seller, purchaser, transaction price, converted price of the transaction price, and fund associated with the digital asset. In this case, when the transaction of digital asset is performed in foreign currency other than the base currency of the user's country of residence or in digital currency, the converted price may be displayed as the amount converted according to the exchange rate at the time of the transaction or the price converted according to the market price of the digital currency exchange at the time of the transaction.

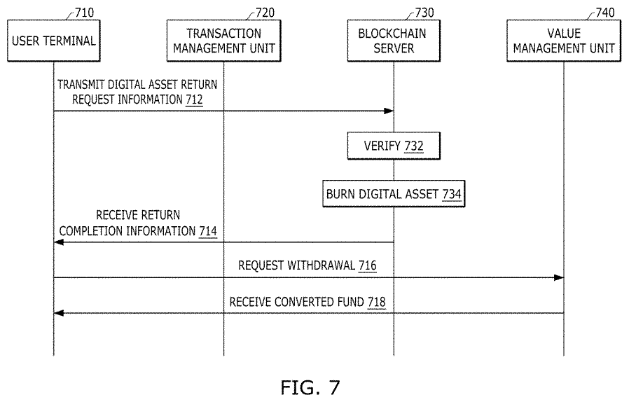

FIG. 7 is a flowchart illustrating a method for performing digital asset burning between a user terminal, and a transaction management unit, a blockchain server and a value management unit of the information processing system according to an embodiment.

As illustrated, at operation 712, a user terminal 710 may transmit digital asset return request information to a blockchain server 730 (or blockchain network) through a transaction management unit 720 of the information processing system. The digital asset return request may be initiated by a user input (not illustrated) to the user terminal 710 of the user.

At operation 732, the blockchain server 730 may verify the transaction history information included in the digital asset return request information received from the transaction management unit 720. In this case, the blockchain server 730 may use a decentralized consensus mechanism for the verification of the digital asset return request information.

At operation 734, when the verification is completed, the blockchain server 730 may burn the digital asset. In an embodiment, burning the digital asset may be performed in such a way that the ownership of the corresponding digital asset is returned to the producer of the digital asset. In this case, the corresponding digital asset may be reproduced or resold in the same form by the original producer. While FIG. 7 illustrates that the blockchain server 730 burns the digital asset, embodiments are not limited thereto, and burning the digital asset may be performed by other components of the information processing system (e.g., the transaction management unit 720 or a value management unit 740).

At operation 714, when verifying the digital asset return request information is completed by the blockchain server 730, the user terminal 710 may receive return completion information (or burn information of the digital asset) through the transaction management unit 720. The return completion information may be displayed as a message on the display of the user terminal 710.

At operation 716, when verifying the digital asset return request information and the digital asset burning are completed by the blockchain server 730, the user terminal 710 may request the value management unit 740 to withdraw an amount equivalent to the fund of the digital asset.

In addition, at operation 718, in response to the request for withdrawal of the user terminal 710, the value management unit 740 may pay the amount equivalent to the fund associated with the digital asset to the user terminal 710. Additionally, the blockchain server 730 (or other component of the information processing system) may delete information associated with the digital asset or generate an invalid flag associated with the digital asset to record the digital asset burning.

The user terminal 710 may be an example of the user terminal 210 and the transaction management unit 720, blockchain server 730 and value management unit 740 may be examples of the corresponding functions performed by the processor 334 of the information processing system 230 discussed with reference to FIGS. 3 and 4.

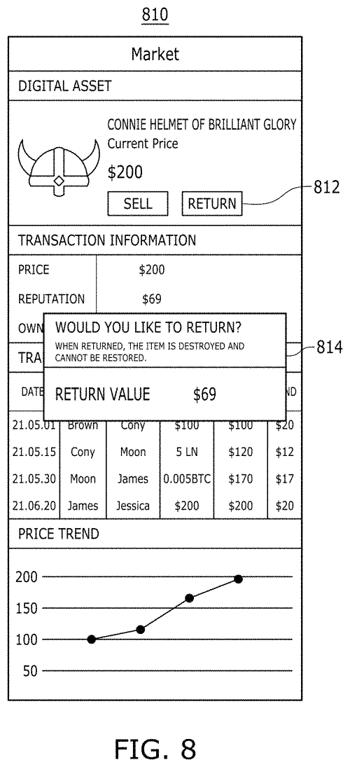

FIG. 8 is a diagram illustrating an example of a user interface on which digital asset burning is performed according to an embodiment. As illustrated, operation 810 illustrates an example of use of a user interface provided by a digital asset transaction application for C2C market. At operation 810, the user interface displays an icon 812 for digital asset return, and a return value of the digital asset and a non-recoverability message 814 of the digital asset. The user may touch the icon 812 on the user interface provided by the digital asset transaction application to initiate a request for digital asset return.

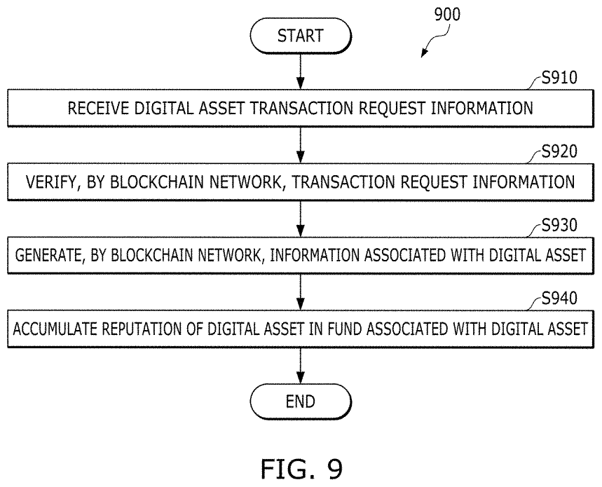

FIG. 9 is a flowchart illustrating a method for transaction of digital asset according to an embodiment. The method 900 for transaction of digital asset may be performed by the information processing system 230 (for example, by the processor 334 of the information processing system 230).

In operation 5910, the method 900 for transaction of digital asset may be initiated by the processor 334 of the information processing system 230 receiving the digital asset transaction request information from the user terminal 210.

In operation 5920, the processor 334 may verify the digital asset transaction request information using the blockchain network. In an embodiment, verifying transaction request information may be performed using a decentralized consensus mechanism of the blockchain network.

In operation 5930, when verifying the transaction request information is completed, the processor 334 may generate information associated with the digital asset. In this case, the information associated with the digital asset may include information on transaction date, producer, purchaser, seller, price, or ownership information associated with the transaction of the digital asset. In addition, the information associated with the digital asset may include a reputation of the digital asset.

In operation 5940, the processor 334 may remit and accumulate an amount equivalent to the calculated reputation in a fund associated with the digital asset.

For example, the reputation of the digital asset may be calculated based on a portion of an amount equivalent to the price of the digital asset. In another example, the reputation of the digital asset may be calculated based on a transaction fee of the digital asset. When a subsequent transaction of the digital asset occurs, the reputation of the digital asset may be newly calculated and it may be different from the reputation calculated in the previous transaction. In this case, an amount equivalent to the reputation may be remitted in real money or virtual currency and accumulated in the fund, or information and the like on the amount may be received and accumulated in the form of data without a separate remittance.

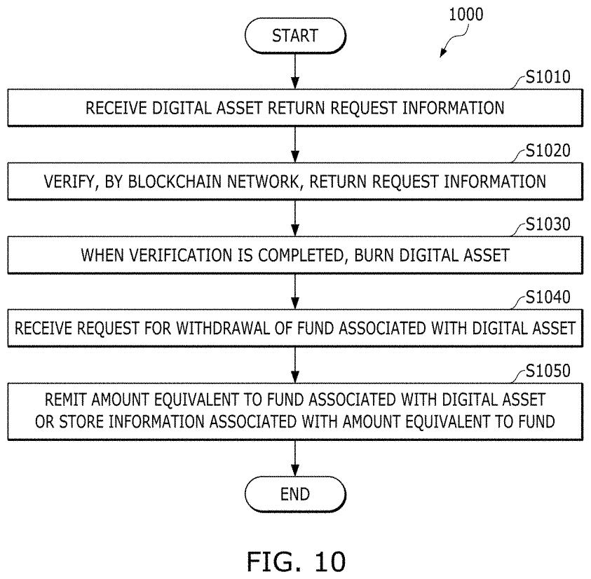

FIG. 10 is a flowchart illustrating a method for burning a digital asset according to an embodiment. The method 1000 for burning digital asset may be performed by the information processing system 230 (or the processor 334 of the information processing system 230).

In operation S1010, the method 1000 for burning digital asset may be initiated by the processor 334 of the information processing system 230 receiving the digital asset return request information from the user terminal 210.

In operation S1020, the processor 334 of the information processing system 230 may verify the digital asset return request information using the blockchain network. In an embodiment, verifying the return request information may be performed using a decentralized consensus mechanism of the blockchain network.

In operation S1030, when verifying the return request information is completed, the processor 334 of the information processing system 230 may burn the digital asset using the blockchain network. In an embodiment, burning the digital asset may be performed in such a way that the ownership of the digital asset is returned to the producer of the digital asset, and in this case, the digital assets may be reproduced or resold in the same form by the producer.

In operation S1040, when verifying the digital asset return request and digital asset burning are completed by the blockchain server, the processor 334 of the information processing system 230 may receive a request for withdrawal of an amount equivalent to the fund of the digital asset from the user termina 210.

In operation S1050, when it is determined that the digital asset is to be burned, the processor 334 may remit an amount equivalent to the fund associated with the digital asset to the user terminal 210 in response to the request for withdrawal of the user terminal 210. Additionally or alternatively, the processor 334 of the information processing system 230 may store information associated with the amount equivalent to the fund. In this case, the information associated with the amount equivalent to the fund may include information associated with the sender (or user terminal) of the return request information.

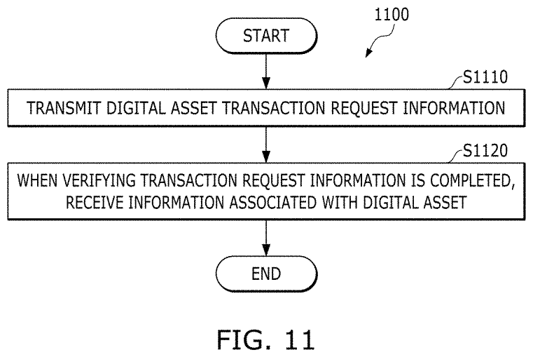

FIG. 11 is a flowchart illustrating a method for transaction of digital asset by the user terminal according to an embodiment. The method 1100 for transaction of digital asset may be performed by the user terminal 210 (or the processor 314 of the user terminal 210).

In operation 51110, the method 1100 for transaction of digital asset may be initiated by the processor 314 of the user terminal 210 transmitting digital asset transaction request information to the information processing system.

In operation S1120, when verifying the transaction request information is completed, the processor 314 of the user terminal 210 may receive information associated with the digital asset. In this case, the information associated with the digital asset may include price, reputation, owner information, and transaction history of the digital asset. The transaction history of the digital asset may include information on transaction date, seller, purchaser, transaction price, converted price of the transaction price, and fund associated with the digital asset.

The method for transaction of digital asset described above may be implemented as a computer-readable code on a computer-readable recording medium. The computer-readable recording medium includes all kinds of recording devices in which data readable by a computer system is stored. Examples of computer readable recording medium include ROM, RAM, CD-ROM, magnetic tape, floppy disks, and optical data storage devices, and other kinds of non-transitory computer-readable mediums. In addition, the computer readable recording medium may be distributed over network coupled computer systems so that the computer readable code is stored and executed in a distributed manner. Further, programmers in the technical field pertinent to the present disclosure will be easily able to envision functional programs, codes and code segments to implement the embodiments.

The methods, operations, or techniques of the present disclosure may be implemented by various means. For example, these techniques may be implemented in hardware, firmware, software, or a combination thereof. Those skilled in the art will further appreciate that various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the present disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any related processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transmission of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transmit or store desired program code in the form of instructions or data structures and can be accessed by a computer. In addition, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the embodiments described above have been described as utilizing aspects of the currently disclosed subject matter in one or more standalone computer systems, embodiments are not limited thereto, and may be implemented in conjunction with any computing environment, such as a network or distributed computing environment. Furthermore, the aspects of the subject matter in the present disclosure may be implemented in multiple processing chips or devices, and storage may be similarly influenced across a plurality of devices. Such devices may include PCs, network servers, and portable devices.

Although the present disclosure has been described in connection with some embodiments herein, various modifications and changes can be made without departing from the scope of the present disclosure, which can be understood by those skilled in the art to which the present disclosure pertains. In addition, such modifications and changes should be considered within the scope of the claims appended herein.

1. A method of transacting a digital asset by an information processing system, the information processing system including a processor, the method comprising:
receiving, from a user terminal, transaction request information associated with the digital asset;
verifying the transaction request information using a blockchain network; and
generating information associated with the digital asset using the blockchain network such that the information associated with the digital asset includes a reputation of the digital asset.

2. The method according to claim 1, further comprising:
accumulating the reputation in a fund associated with the digital asset.

3. The method according to claim 1, wherein the verifying the transaction request information comprises:
generating and storing a transaction history of the digital asset based on the digital asset transaction request information;
generating a first signature key for the digital asset;
transmitting the first signature key to the user terminal;
generating a second signature key for the digital asset; and
storing the second signature key in association with the digital asset.

4. The method according to claim 1, further comprising:
receiving a return request information;
verifying the return request information using the blockchain network; and
burning the digital asset, in response to the verifying confirming a validity of the return request information.

5. The method according to claim 4, wherein the verifying the return request information comprises:
determining whether a sender of the return request information is an owner of the digital asset based on an encryption key included in the return request information.

6. The method according to claim 4, wherein the burning the digital asset includes:
calculating a fund associated with the digital asset based on the return request information;
deleting information associated with the digital asset or generating an invalid flag associated with the digital asset; and
transmitting return information to a sender of the return request information such that the return information includes the fund associated with the digital asset.

7. The method according to claim 4, wherein the return request information is received from the user terminal, and the method further comprises:
transmitting, to the user terminal, burn information of the digital asset, in response to the burning of the digital asset.

8. The method according to claim 7, wherein the user terminal is configured to output a non-recoverability message or a returned fund of the digital asset based on the burn information.

9. The method according to claim 4, further comprising:
receiving a request for withdrawal of a fund associated with the digital asset from a sender of the return request information; and
remitting, to the sender, an amount equivalent to the fund associated with the digital asset or storing information associating the amount equivalent to the fund with the sender.

10. The method according to claim 9, wherein the request for withdrawal of the fund associated with the digital asset is received from the user terminal, and
wherein the user terminal is configured to receive the amount equivalent to the fund associated with the digital asset or output the information associated with the amount equivalent to the fund.

11. The method according to claim 1, further comprising:
converting a transaction amount or the reputation of the digital asset into cash using a digital currency exchange, in response to transacting the digital asset using the digital currency exchange.

12. The method according to claim 1, wherein the digital asset includes a non-fungible token (NFT)-based digital asset.

13. The method according to claim 1, wherein the information associated with the digital asset further includes information on at least one of a transaction date, a producer, a purchaser, a seller, a price or ownership information associated with the digital asset.

14. The method according to claim 1, further comprising:
transmitting, to the user terminal, the information associated with the digital asset including the reputation of the digital asset, wherein
the user terminal is configured to confirm the reputation of the digital asset based on the information associated with the digital asset transmitted thereto.

15. The method according to claim 11, wherein the user terminal is configured to extract information on a transaction date, a producer, a purchaser, a seller or a price of the digital asset from the information associated with the digital asset.

16. A non-transitory computer-readable recording medium storing instructions for executing the method of claim 1.

17. A system configured to transact a digital asset, comprising:
a user terminal; and
an information processing system including,
a memory configured to store computer-readable instructions, and
a processor connected to the memory and configured to the computer-readable instructions to configure the information processing system to,
receive, from the user terminal, transaction request information associated with the digital asset,
verify the transaction request information using a blockchain network, and
generate information associated with the digital asset using the blockchain network such that the information associated with the digital asset includes a reputation of the digital asset.

18. The system according to claim 17, wherein the computer-readable instructions, when executed by the processor, further configure the information processing system to accumulate the reputation in a fund associated with the digital asset.

19. The system according to claim 17, wherein the user terminal is configured to,
transmit the digital asset transaction request information to the information processing system,
receive information associated with the digital asset, when the information processing system verifies the transaction request information using the blockchain network, and
confirm the reputation of with the digital asset included in the information received from the information processing system.

20. The system according to claim 19, wherein the user terminal is configured to,
transmit return request information to the information processing system, and
receive burn information of the digital asset, in response to the information processing system verifying, based on the return request information, that the return request is completed using the blockchain network.
